(19) United States
(12) Patent Application Publication
(10) Pub. No.: US 2013/0163952 A1
(43) Pub. Date: Jun. 27, 2013

(54) VIDEO PRESENTATION APPARATUS, VIDEO PRESENTATION METHOD, VIDEO PRESENTATION PROGRAM, AND STORAGE MEDIUM

(71) Applicants: Chanbin Ni, Osaka-shi (JP); Junsei Sato, Osaka-shi (JP); Hisao Hattori, Osaka-shi (JP)

(72) Inventors: Chanbin Ni, Osaka-shi (JP); Junsei Sato, Osaka-shi (JP); Hisao Hattori, Osaka-shi (JP)

(73) Assignee: SHARP KABUSHIKI KAISHA, Osaka-shi, Osaka (JP)

(21) Appl. No.: 13/820,188

(22) PCT Filed: Aug. 30, 2011
(86) PCT No.: PCT/JP2011/069618

§ 371 Date: Mar. 1, 2013

(30) Foreign Application Priority Data
Sep. 2, 2010 (JP) 2010-196830

(51) Int. Cl. H04N 5/60

(52) U.S. Cl. CPC H04N 5/607
USPC 386/230

(57) ABSTRACT

Provided is a video presentation apparatus enabling the user to easily ascertain the associative relationship between video and audio.

A video presentation apparatus according to the present invention sets a virtual sound source at the position where a video is being displayed, and forms a sound field that imitates the state of audio being produced from the virtual sound source (see FIG. 3).

### TECHNICAL FIELD

The present invention relates to technology that presents video.

### BACKGROUND ART

Information is now being delivered to the home from a variety of media. For example, TV and radio audiovisual broadcasts are being delivered to the home via terrestrial broadcasting, satellite broadcasting, and CATV cable.

In addition, digital broadcasting systems that transmit a digitized television signal by Communication Satellite (CS) broadcasting or cable TV (CATV) are now becoming more prevalent. In these systems, it is possible to obtain even several hundred channels by implementing digital compression and transmission technologies. For this reason, it is becoming possible to provide more television/radio (music) programs than ever before.

Also, as AV equipment continues to go digital, households now contain multiple instances of audiovisual sources provided as packaged media, such as Digital Versatile Discs (DVDs), Digital Video (DV), and digital cameras, as well as audiovisual sources on which broadcast content has been recorded by a device such as a digital video recorder.

Furthermore, it is thought that the forthcoming digitization of broadcasting and communication infrastructure improvements will expand the number of routes along which audiovisual information flows into the home.

In this way, although there are an increasing number of services providing a diversity of video and audio information from various media, users have limited time to partake of these services. Consequently, multi-window playback functions have been recently realized, which open multiple windows simultaneously on a large display, and assign different information sources for playback to the individual windows.

Also proposed is a multi-window video searching system that uses the above multi-window display function to display an overview of many videos at once, so that the user may search for desired content. When the user is watching a given video but takes interest in a different video among the overview of multiple videos displayed on-screen, the user is able to instantaneously check the content of that video without changing the display on-screen. By taking advantage of his or her own visual processing ability, the user is able to check many search results at once, and efficiently find a desired program to watch.

In the above multi-window video searching system, if the audio of the video content were to output simultaneously with the respective videos, and if the user could distinguish the respective audio, such audio would be effective as auxiliary information for rapidly checking the content of a video. Thus, a method enabling the simultaneous viewing of multiple videos displayed by a multi-window function together with their audio has been proposed.

PTL 1 below describes a technology that simultaneously emits the audio corresponding to multiple videos displayed on a screen from speakers positioned in correspondence to the display positions of the videos. Thus, the user is able to sensuously associate the videos being displayed on-screen simultaneously with their audio.

PTL 2 below describes a technology that adjusts the volume balance of audio signals combined in the speakers installed at left, center, and right so as to match the size and positions of windows displaying videos. Thus, the user is able to sensuously recognize the associative relationship between the respective audio combined by the speakers and the windows according to the volume.

PTL 3 below describes a technology that restricts the frequency band of the audio signal for the sub-screen to a narrow band approximately like that of a telephone. Thus, the user is able to distinguish the main screen audio and the sub-screen audio on the basis of audio quality differences.

### CITATION LIST

### Patent Literature

PTL 1: Japanese Unexamined Patent Application Publication No. 8-98102

PTL 2: Japanese Unexamined Patent Application Publication No. 2000-69391

PTL 3: Japanese Unexamined Patent Application Publication No. 9-322094

### SUMMARY OF INVENTION

### Technical Problem

With the technology described in the above PTL 1, the speaker installation positions are fixed. For this reason, enabling the user to suitably ascertain the associative relationship between video and audio requires adjusting factors such as the window display positions and the number of simultaneously output audio channels so as to match the speaker installation positions. In other words, with the technology described in PTL 1, video and audio are readily constrained by the speaker installation positions.

Also, PTL 1 describes an example of simultaneously outputting two videos, in which the audio for the video being displayed on the left window is output from the speaker on the left side of the screen, while the audio for the video being displayed on the right window is output from the speaker on the right side of the screen. However, PTL 1 does not describe the specific methodology of how to subdivide the screen and associate each video with particular speakers when simultaneously displaying three or more videos.

With the technology described in the above PTL 2, suitably ascertaining the associative relationship between the video in windows and the audio requires the user to be positioned in a place where the distance between the user and the left speaker is approximately equal to the distance between the user and the right speaker. For example, in the case where the user is positioned much closer to the right speaker, the audio output from the right speaker will seem to be produced nearby. For this reason, even if the window layout is uniform left-to-right, the audio from the right video only will sound loud, disrupting the balance between the video and audio.

Given circumstances like the above, PTL 2 is able to accommodate the case where a single user is positioned in front of the screen, but there is a possibility that it may be difficult to accommodate situations where multiple users are side-by-side in front of the screen.

With the technology described in the above PTL 3, there is a possibility of overlap between the frequency band of the main screen audio where information density is high, and the frequency band of the sub-screen audio that is output after being filtered. At such times it will be difficult for the user to distinguish the audio.

In other words, with PTL 3, it may be difficult for the user to associate video and audio in some cases, depending on the combination of main screen audio and sub-screen audio. Also, like PTL 1, PTL 3 does not describe the specific methodology of how to associate each video with particular speakers when simultaneously displaying three or more videos.

The present invention has been devised in order to solve problems like the above, and takes as an object thereof to provide a video presentation apparatus enabling the user to easily ascertain the associative relationship between video and audio.

### Solution to Problem

A video presentation apparatus according to the present invention sets a virtual sound source at the position where a video is being displayed, and forms a sound field that imitates the state of audio being produced from the virtual sound source.

### Advantageous Effects of Invention

According to a video presentation apparatus according to the present invention, the on-screen position of a video and the sound source positions recognized by the user is the same, and thus the user is able to easily ascertain the associative relationship between video and audio.

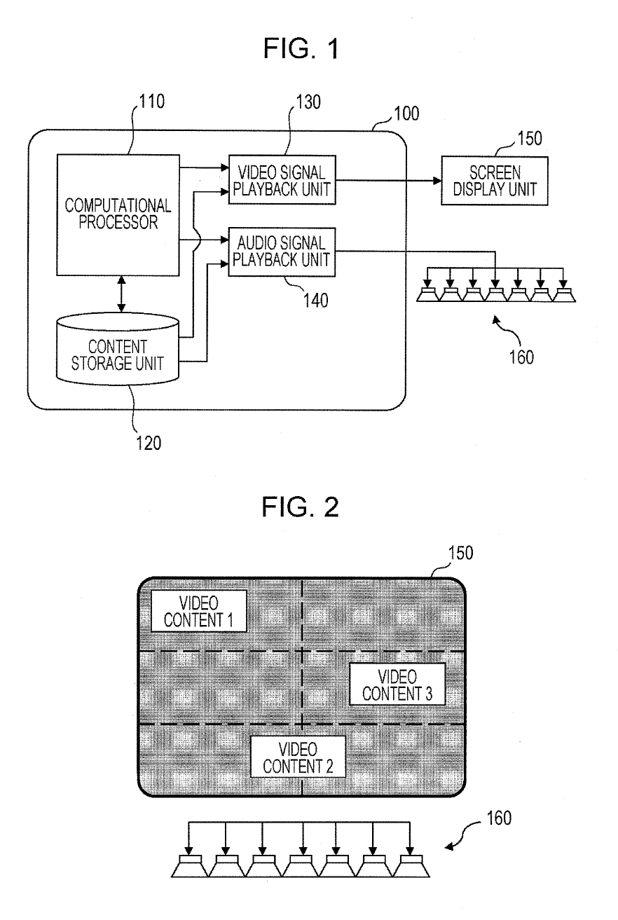

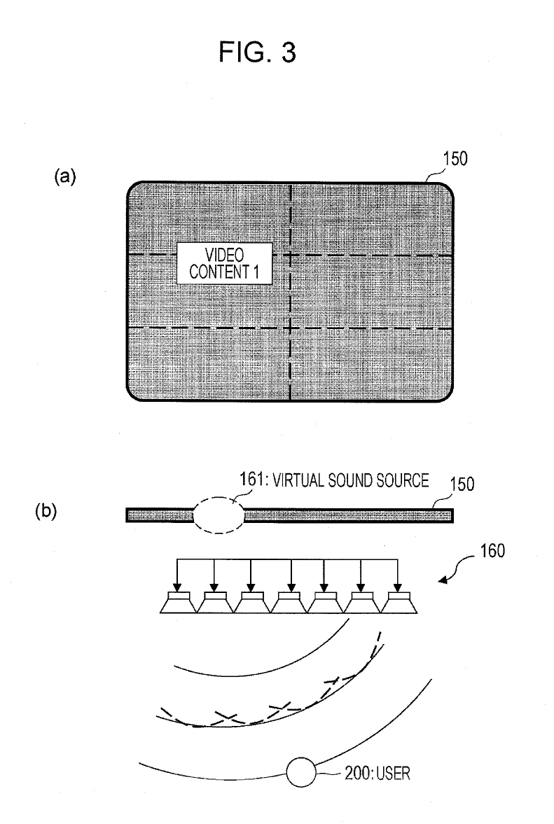

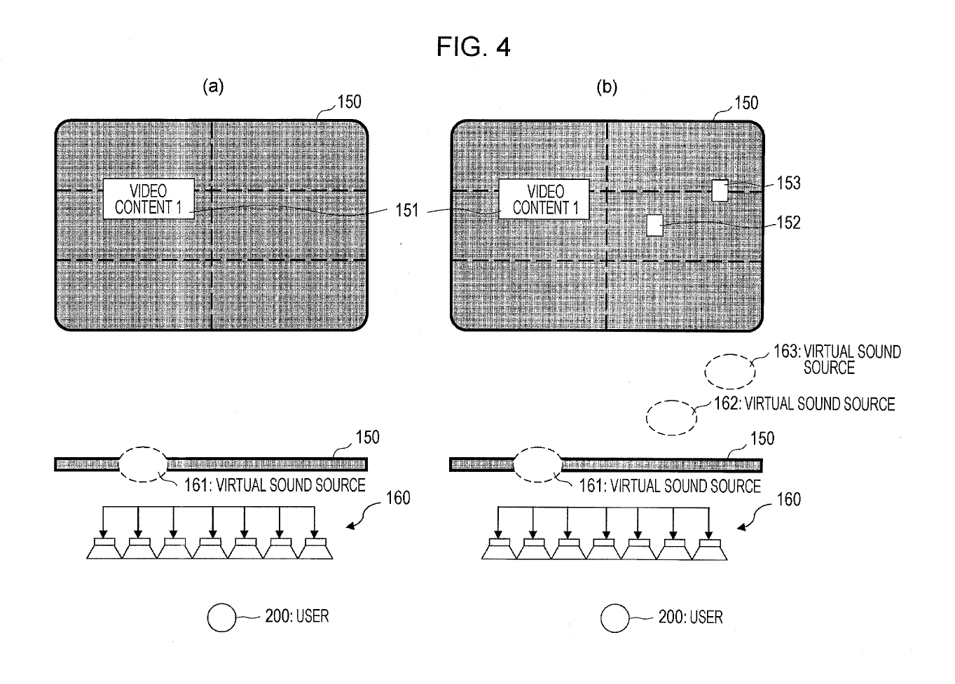

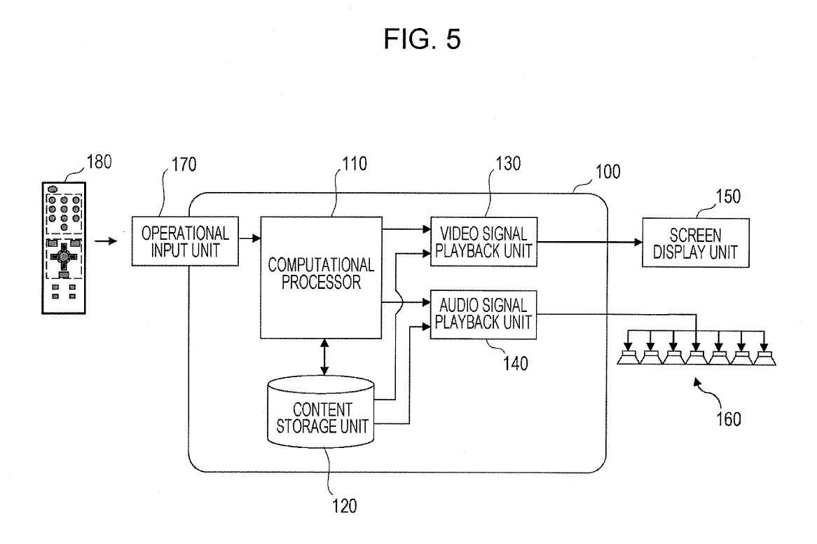

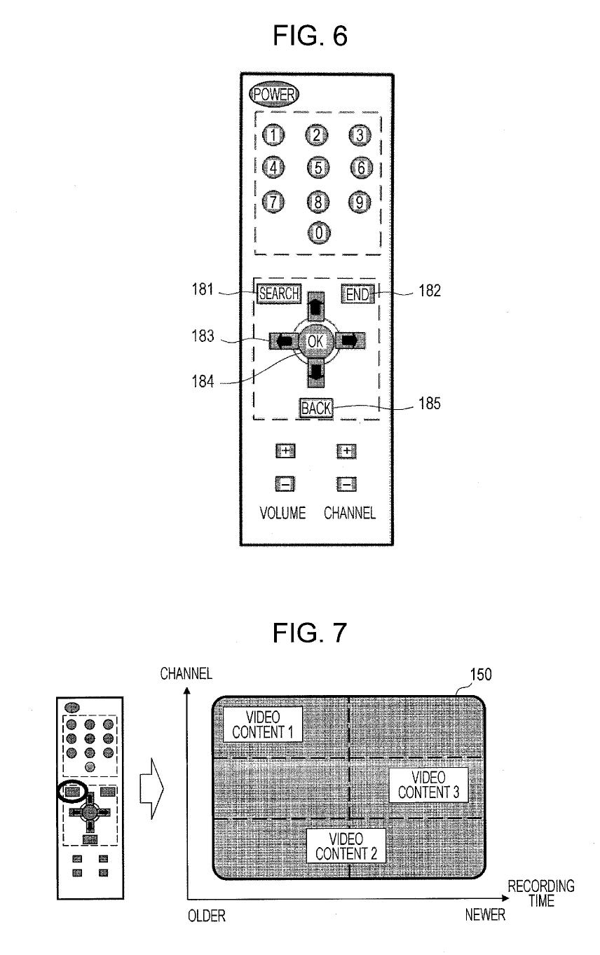

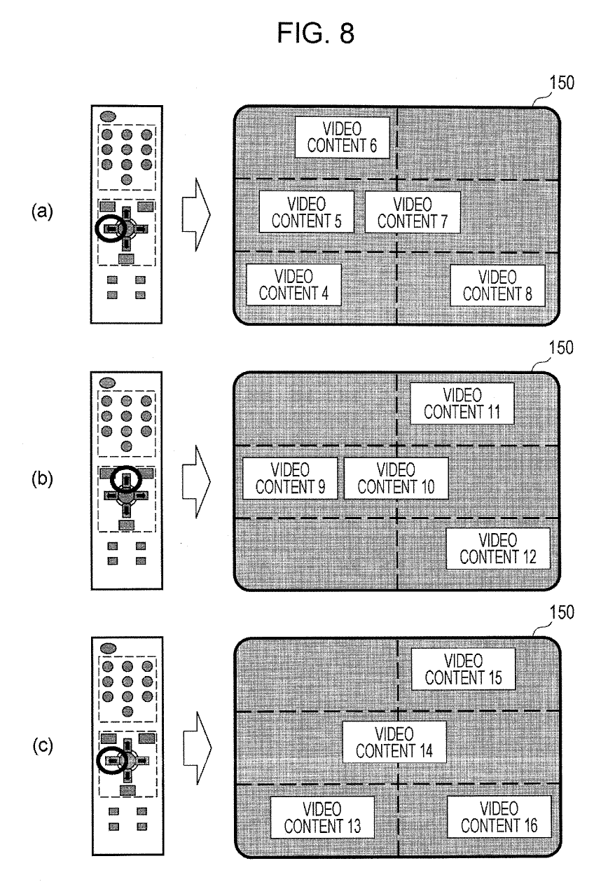

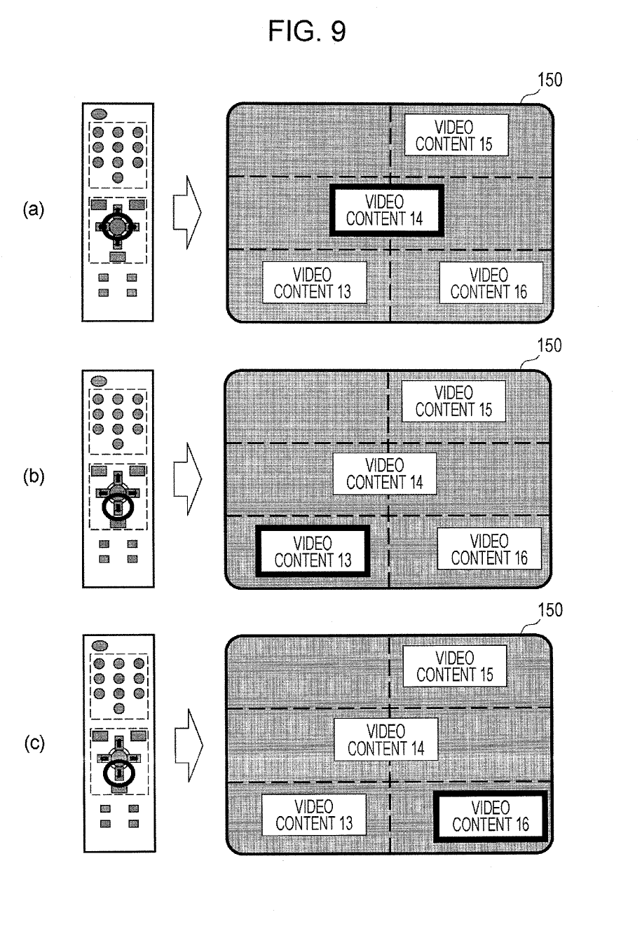

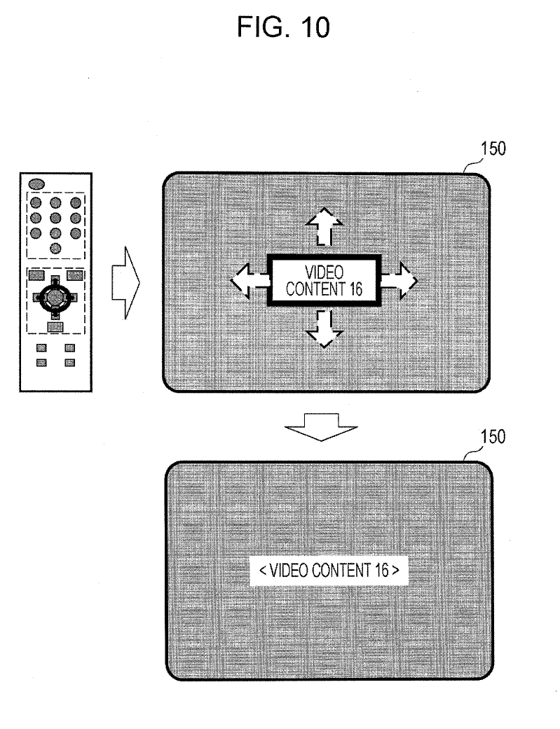

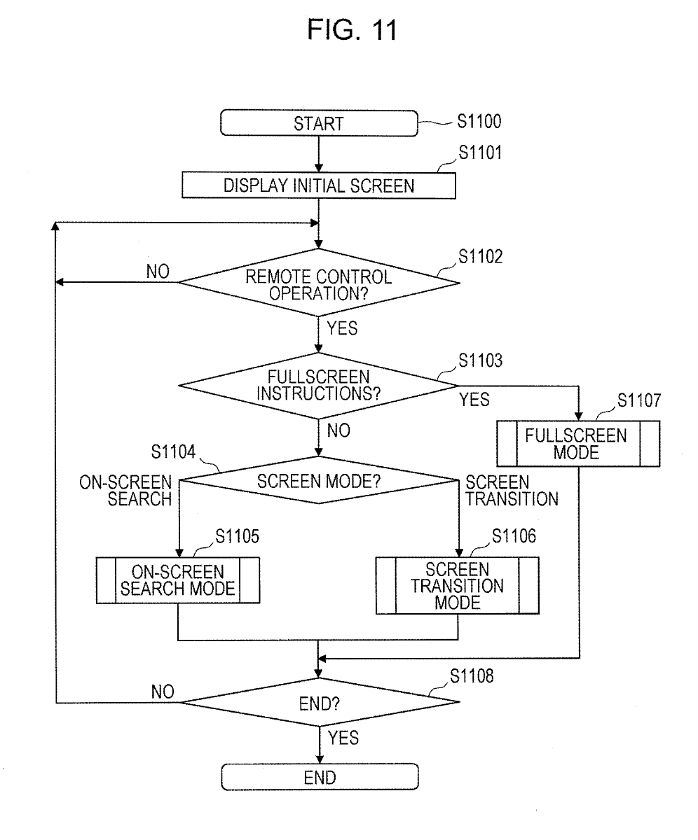

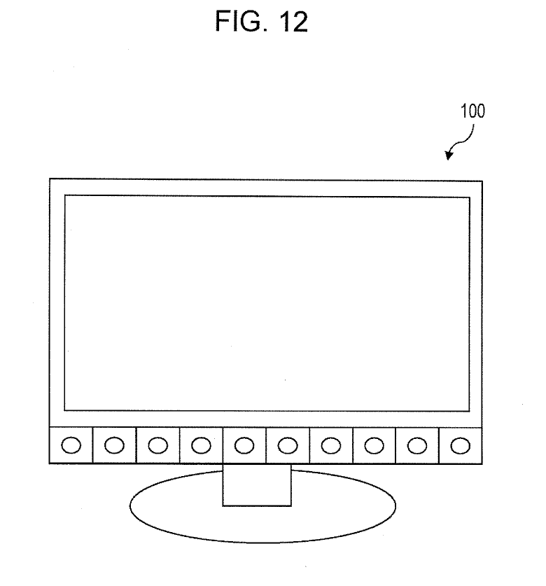

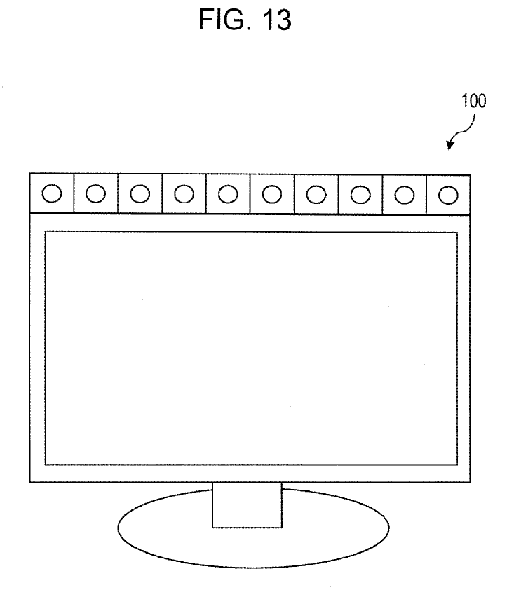

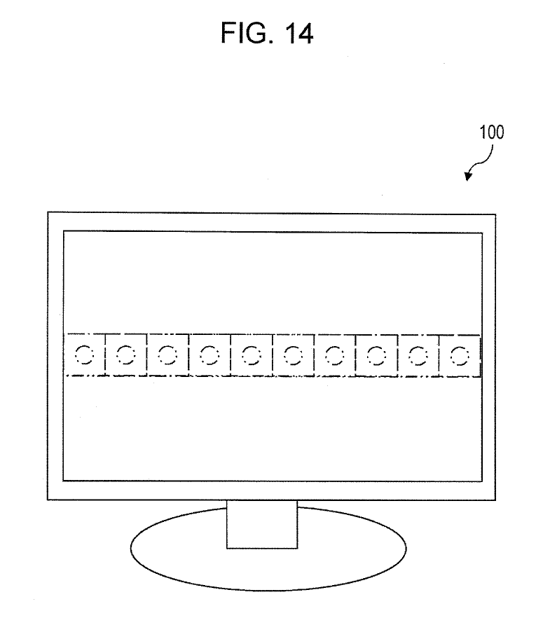

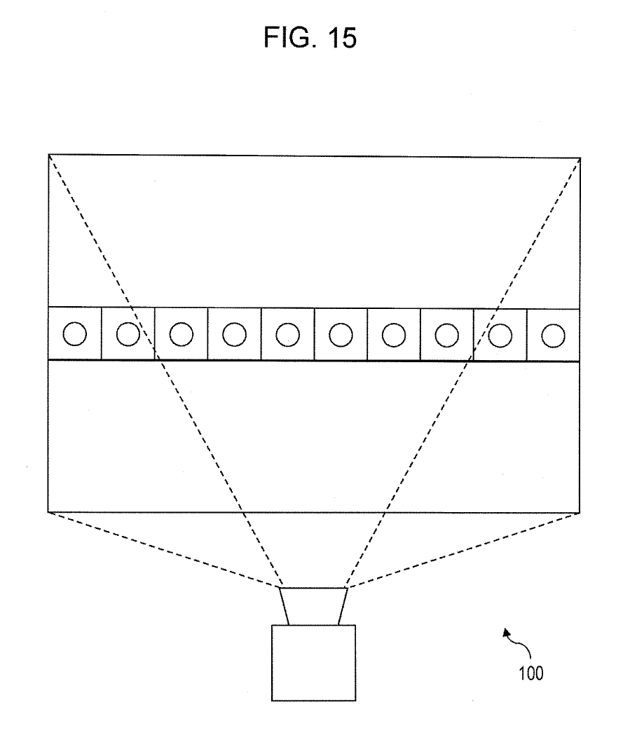

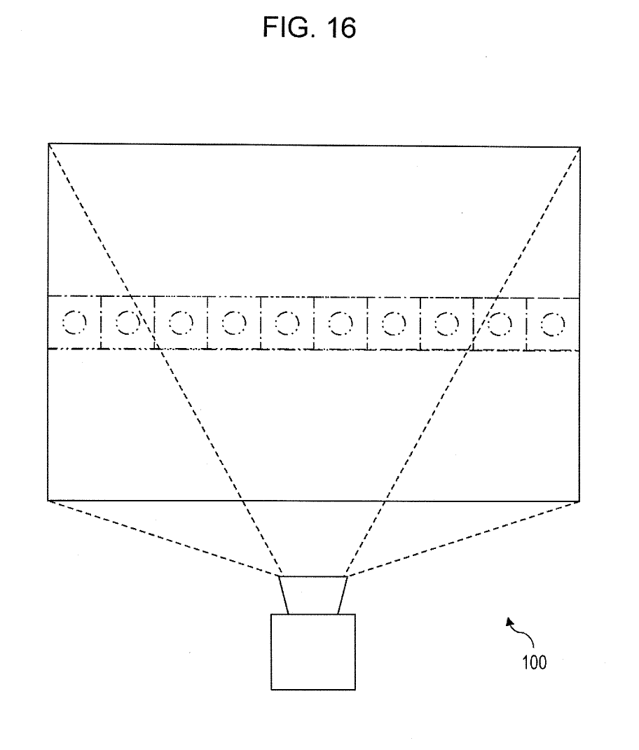

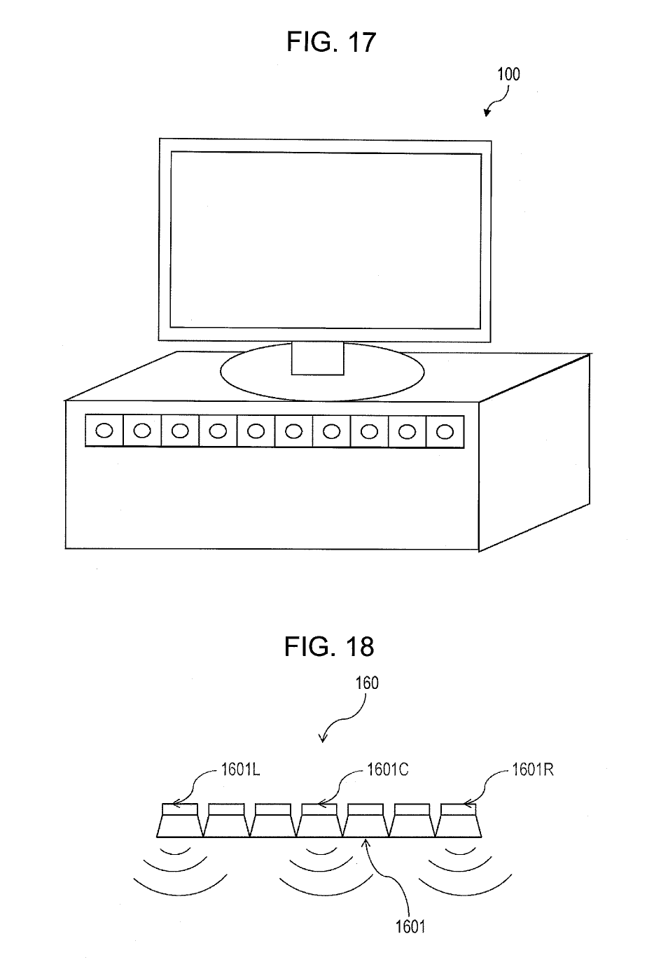

### BRIEF DESCRIPTION OF DRAWINGS

[FIG. 1] FIG. 1 is a function block diagram of a video presentation apparatus 100 according to Embodiment 1.

[FIG. 2] FIG. 2 is a diagram illustrating an exemplary screen display by a screen display unit 150.

[FIG. 3] FIG. 3 is a diagram illustrating how an audio output unit 160 uses a wave field synthesis technique to imitate a sound field produced from a virtual sound source 161.

[FIG. 4] FIG. 4 is a diagram illustrating an example of setting the depth position of a virtual sound source 161 behind the screen display unit 150, or in other words on the side away from a user 200.

[FIG. 5] FIG. 5 is a function block diagram of a video presentation apparatus 100 according to Embodiment 3.

[FIG. 6] FIG. 6 is a diagram illustrating details of buttons provided on a remote control 180.

[FIG. 7] FIG. 7 is a diagram illustrating an exemplary initial screen in a screen transition mode.

[FIG. 8] FIG. 8 is a diagram illustrating exemplary screen transitions in a screen transition mode.

[FIG. 9] FIG. 9 is a diagram illustrating exemplary screen transitions in an on-screen selection mode.

[FIG. 10] FIG. 10 is a diagram illustrating an exemplary screen transition when the user presses an OK button 184 on a remote control 180 while in an on-screen selection mode.

[FIG. 11] FIG. 11 is an operational flowchart for a video presentation apparatus 100 according to Embodiment 3.

[FIG. 12] FIG. 12 is a diagram illustrating an example of configuring the video presentation apparatus 100 in FIG. 1 as a television.

[FIG. 13] FIG. 13 is a diagram illustrating an example of configuring the video presentation apparatus 100 in FIG. 1 as a television.

[FIG. 14] FIG. 14 is a diagram illustrating an example of configuring the video presentation apparatus 100 in FIG. 1 as a television.

[FIG. 15] FIG. 15 is a diagram illustrating an example of configuring the video presentation apparatus 100 in FIG. 1 as a video projector system.

[FIG. 16] FIG. 16 is a diagram illustrating an example of configuring the video presentation apparatus 100 in FIG. 1 as a video projector system.

[FIG. 17] FIG. 17 is a diagram illustrating an example of configuring the video presentation apparatus 100 in FIG. 1 as a system made up of a television cabinet and a television.

[FIG. 18] FIG. 18 is a diagram illustrating an exemplary configuration of an audio output unit 160.

### DESCRIPTION OF EMBODIMENTS

### Embodiment 1

FIG. 1 is a function block diagram of a video presentation apparatus 100 according to Embodiment 1 of the present invention. The video presentation apparatus 100 plays back and presents video information and audio information to a user, and is provided with a computational processor 110, a content storage unit 120, a video signal playback unit 130, an audio signal playback unit 140, a screen display unit 150, and an audio output unit 160.

The computational processor 110 controls overall operation of the video presentation apparatus 100. The computational processor 110 also controls the operation of the video signal playback unit 130 and the audio signal playback unit 140. The computational processor 110 may be realized using a computational device such as a central processing unit (CPU), for example. Operation of the computational processor 110 may also be realized by separately providing a program stating control behavior, and having the computational device execute the program.

The content storage unit 120 stores content data recording video information and audio information. The content storage unit 120 may be realized using a storage device such as a hard disk drive (HDD), for example. Content data may be obtained from various content sources such as television broadcast waves, storage media such as DVDs, audiovisual signals output by devices such as video players or video tape recorders, or downloads from servers that deliver digital content via a network, for example. The video presentation apparatus 100 is assumed to be appropriately equipped with interfaces for receiving content data from content sources as necessary.

The video signal playback unit 130 retrieves content data from the content storage unit 120, generates video signals by decoding or otherwise processing video information, and works the generated video signals into a given screen layout after applying video effects or other processing. The video signal playback unit 130 outputs video signals to the screen display unit 150 for display on-screen.

The audio signal playback unit 140 retrieves content data from the content storage unit 120, generates audio signals by decoding or otherwise processing audio information, and after applying audio effects as necessary, D/A conversion, and amplifying the analog signals, outputs the result to the audio output unit 160 for output as audio.

The screen display unit 150 is a display device realized using a liquid crystal display, for example. The screen display unit 150 displays video on the basis of video signals output by the video signal playback unit 130. The process that drives the screen display unit 150 may be executed by the video signal playback unit 130, or by the computational processor 110.

The audio output unit 160 is realized using one or more audio output devices (speakers, for example). Embodiment 1 supposes a speaker array in which multiple speakers are arranged in a line, but the configuration is not limited thereto. For the sake of convenience, the audio output unit 160 is assumed to be installed below the screen display unit 150.

FIG. 2 is a diagram illustrating an exemplary screen display by the screen display unit 150. The video signal playback unit 130 retrieves one or more instances of content data from the content storage unit 120, and generates a video signal causing video information to be displayed at given positions on the screen display unit 150. Herein, an example of simultaneously displaying three instances of video information on the screen display unit 150 is illustrated. The user views the three instances of video content on the screen display unit 150 simultaneously.

The audio output unit 160 individually plays back the respective audio for each instance of video content, but it is desirable for the position of the sound image to match the on-screen display position of each video at this point. This is because by matching the audio with the video, the user is able to associate the video and the audio, and easily ascertain the content.

The foregoing thus describes a configuration of the video presentation apparatus 100. Next, a technique of associating audio with video on the screen display unit 150 will be described in conjunction with a wave field synthesis technique using a speaker array.

### Embodiment 1: Speaker Array

There exists a phenomenon called the cocktail party effect, in which a person is able to naturally pick up and listen to a conversation of interest, even in a busy situation such as a cocktail party. As illustrated by the example of this effect, a person is able to simultaneously distinguish multiple sounds according to the differences in the sound image positions (the spatial imaging of the perceived sounds) as well as the differences in the sounds themselves.

Consider a video presentation apparatus 100 taking advantage of this human auditory ability. If respective sound images could be spatially oriented at the positions of the multiple videos, the user would be able to selectively listen to the audio for a specific video.

In order to naturally distinguish multiple sounds as with the cocktail party effect, it is desirable to bring the sound fields reproduced by the audio output unit 160 as close to the original sound fields as possible. Thus, a wave field synthesis technique using a speaker array is applied to the audio output unit 160.

A wave field synthesis technique hypothesizes a sound source (virtual sound source) behind the speaker array, and synthesizes the wave field of the sound field according to the total combined wavefront emitted from each speaker in the speaker array. Using wave field synthesis makes it possible to reproduce sound directionality and expansiveness, as though a real sound source actually exists at the position of the virtual sound source.

FIG. 3 is a diagram illustrating how the audio output unit 160 uses a wave field synthesis technique to imitate a sound field produced from a virtual sound source 161. For the sake of simplicity herein, the example of the screen display unit 150 displaying one instance of video content on-screen is illustrated.

FIG. 3(a) illustrates an exemplary screen display by the screen display unit 150. It is assumed that the video signal playback unit 130 has caused the screen display unit 150 to display one instance of video content at a position slightly to the left when facing the screen. The user views the video content while imagining that sound is being produced from the position where the video content is being displayed on-screen.

FIG. 3(b) is a top view of the screen display unit 150 and the audio output unit 160 as seen from above. The audio signal playback unit 140 hypothesizes that a sound source exists at the on-screen position of the video content illustrated in FIG. 3(a), and sets the virtual sound source 161 to that position. It is assumed that the user 200 is positioned in front of the screen display unit 150. Specifically, the computational processor 110 acquires the position of the on-screen video display window (such as the center coordinates of the window) from the video signal playback unit 130, and causes the audio signal playback unit 140 to set this position as the position of the virtual sound source 161.

In the case where the virtual sound source 161 is at the position illustrated in FIG. 3(b), the user 200 imagines that a wave field like that indicated by the solid arcs in FIG. 3(b) is being formed. If this wave field is reproduced by wave field synthesis, the user 200 perceives the illusion of a sound source existing at the position of the virtual sound source 161, and is able to associate the on-screen position of the video content with the sound source position.

In order to imitate the wave field indicated by the solid arcs in FIG. 3(b), the audio signal playback unit 140 may synthesize a wavefront produced by each speaker as indicated by the broken arcs, and control the audio output from each speaker so the synthesized waves become the solid arcs. In so doing, the wavefront reaching the user 200 becomes like the solid arc, making it possible to imitate a sound field in which audio is produced from the virtual sound source 161.

Although this example assumes playback according to a wave field synthesis playback method for the sake of convenience, attempting to reproduce a wave field within the band of actual audible frequencies involves arraying speakers at intervals of 8.5 mm on a two-dimensional plane, which is unrealistic. For this reason, products using speakers with realistic apertures have emerged in the market on the basis of approximation using a linear speaker array, as with wave field synthesis (WFS). In these implementations, wave field synthesis is only possible for components in the low-frequency band, but even with such approximations it is still possible to create a perceived effect resembling the case of synthesizing a wave field. The present invention also presumes an approximate playback method according to such an implementation.

Also, from a psychoacoustic perspective, the clue to sound image localization is taken to be the sound pressure differences and time differences of sound entering both ears. If wave field synthesis is interpreted as a technique causing multiple users to simultaneously hear such sounds, then any type of playback technique is acceptable insofar as the playback technique produces such an effect, without strictly attempting to synthesize a wave field.

Regardless of the playback technique, the audio output unit 160 needs to know the position of each speaker for actual playback. However, since speakers are installed at fixed positions in ordinary equipment, the speaker positions may be taken to be established. Alternatively, the speakers may be movable, and when such movement occurs, the new speaker positions may be set automatically or by a user operation.

Note that FIG. 3 illustrates an example of synthesizing a wave field in a horizontal plane for the sake of convenience. This takes advantage of the fact that human hearing is typically less sensitive to misalignments of audio and video in the vertical direction than to misalignments in the horizontal direction. Furthermore, this takes advantage of what may be called a ventriloquism effect, in which the audio corresponding to video is drawn towards that video when presenting the video while also presenting the audio from a location that differs from the video position. If the horizontal position of a virtual sound source is reproduced according to these effects of perception, the user will perceive the illusion of sound coming from a video, even if the audio position in the vertical direction (the height of the audio position) is misaligned with that video. Consequently, it is sufficient to linearly arrange speakers in the horizontal direction along the top edge or the bottom edge of the screen, and output sound such that video and audio are not misaligned left and right.

In this case, the virtual sound source position may be positioned on or near a straight line extending vertically from the video position, without necessarily matching the video position. In addition, the virtual sound source does not need to be positioned on or behind the screen, and may be positioned on, in front of, or behind the speaker array, for example. However, obviously it may be configured such that a wave field is also synthesized in the vertical direction.

For example, assume that a virtual sound source 161 is positioned at the vertical position where the screen display unit 150 is displaying video content on-screen, and that the audio output from each speaker is controlled. The speaker array may also be disposed in multiple layers in the vertical direction to conduct wave field synthesis in the vertical direction.

Among ordinary video content, not only monaural audio but also stereo (2 ch) and surround sound (5.1 ch) are widely prevalent. The technique of the present invention involves downmixing to monaural audio in order to play back content having these multi-channel audio signals in association with a single virtual sound source. Methods ordinarily used for devices such as televisions may be conducted as the downmixing method. Alternatively, for surround sound, since the rear channel audio signal often contains reverb components and may possibly make sound image localization more difficult with ordinary downmixing techniques, only the three front channels (FR, FC, and FL) only may be used, by adding the front channels together and dividing by 3, for example.

Likewise in the case where the screen display unit 150 simultaneously displays multiple instances of video content, virtual sound sources 161 for the individual instances of video content may be individually set according to a technique similar to FIG. 3 to imitate a sound field associating the on-screen position of each instance of video content with the positions of the virtual sound sources 161. Thus, the user is able to easily make associations between the positions of the virtual sound sources 161 and the on-screen positions of the multiple instances of video content.

In Embodiment 1, the audio signal playback unit 140 is described as determining the position of the virtual sound source 161 for the sake of simplicity, but it may also be configured such that the computational processor 110 conducts computational processing or other behavior for that purpose. This applies similarly to the embodiments hereinafter.

### Embodiment 1: Summary

As above, a video presentation apparatus 100 according to Embodiment 1 sets the position of a virtual sound source 161 at the position where the screen display unit 150 is displaying video, and causes the audio output unit 160 to imitate a sound field as though audio were being produced from the virtual sound source 161. Thus, the user is able to easily associate the video position on the screen display unit 150 with the audio heard from the audio output unit 160.

Also, according to a video presentation apparatus 100 in accordance with Embodiment 1, the user is able to easily identify desired video content while associating video and audio, regardless of the layout of video content displayed on-screen by the screen display unit 150. Thus, it is possible to rapidly find desired video content in an arbitrary on-screen layout.

This effect is effective in multi-user environments where the on-screen layout differs for each user. In other words, in the related art it has been difficult to associate video positions with sound source positions in the case where individual users customize the on-screen layout, since the locations where instances of video content are displayed on-screen differ individually. According to Embodiment 1, it is possible to freely associate virtual sound source positions with video display positions, and thus video and audio may be flexibly associated, regardless of the on-screen layout.

### Embodiment 2

Although Embodiment 1 assumes that the virtual sound source 161 is disposed along the screen display unit 150, the position of the virtual sound source may be set arbitrarily. For example, the virtual sound source 161 may also be positioned farther away from the user than the screen display unit 150. In Embodiment 2 of the present invention, one such example will be described. The configuration of the video presentation apparatus 100 is similar to that described in Embodiment 1.

FIG. 4 is a diagram illustrating an example of setting the depth position of a virtual sound source 161 behind the screen display unit 150, or in other words on the side away from a user 200. For comparison, an example of disposing a virtual sound source 161 similarly as in FIG. 3 is also illustrated in FIG. 4(a).

In FIG. 4(b), the screen display unit 150 is simultaneously displaying three instances of video content on-screen. The position and size of the video content 151 is similar to FIG. 4(a). The other two instances of video content, 152 and 153, are disposed to the right when facing the screen display unit 150. The on-screen size of the video content 152 is smaller than the video content 151, and the on-screen size of the video content 153 is even smaller.

Typically, the user will expect that the volume will be low for video displayed at a small size. The audio signal playback unit 140 causes this expectation to be reflected in the position of the virtual sound sources, and sets the position of the virtual sound source for each instance of video content.

In FIG. 4, the position of the virtual sound source 162 for the video content 152 is set farther behind the position of the virtual sound source 161. The virtual sound source 162 is positioned farther away from the user 200 than the virtual sound source 161, reflecting the fact that the on-screen size of the video content 152 is smaller than the on-screen size of the video content 151. The position of the virtual sound source 163 for the video content 153 is set even farther behind.

The relationship between the display sizes of the video content and the depths of the virtual sound sources is determined by taking the content being displayed at the largest size on-screen (in FIG. 4, the video content 151) to have a depth of 0, and computing the relative depths of the video content 152 and 153 according to the on-screen sizes of the video content as seen by the user. The virtual sound source depth information computed in this way is output to the computational processor by the video playback unit 130 simultaneously with the on-screen positions of the virtual sound sources (the center coordinates of the display windows), and set in the audio information playback unit 140.

Since the method of reproducing the position of a virtual sound source in the depth direction is typically defined according to the particular playback method that uses the concept of virtual sound sources, the technique for setting the position of a virtual sound source may vary according to the particular playback method. Ordinarily, the volume is adjusted or the phase of the wave field is adjusted, for example.

### Embodiment 2: Summary

As above, a video presentation apparatus 100 according to Embodiment 2 sets the depth of a virtual sound source corresponding to a video according to the size at which the screen display unit 150 displays that video on-screen. Thus, since the user is able to easily ascertain the associative relationship between the on-screen video size and the audio, the user is able to immediately understand which audio corresponds to which video.

### Embodiment 3

Embodiment 3 of the present invention describes an operational example of changing the displayed video content by scrolling or moving the screen displayed by the screen display unit 150. In addition, a remote control is given as an example of an input device by which the user issues instructions for changing the screen to the video presentation apparatus 100.

FIG. 5 is a function block diagram of a video presentation apparatus 100 according to Embodiment 3. The video presentation apparatus 100 according to Embodiment 3 includes an operational input unit 170 and a remote control 180 in addition to the configuration described in Embodiments 1 and 2. All other items not related to the operational input unit 170 and the remote control 180 are similar to Embodiments 1 and 2.

The remote control 180 is an input device with which the user issues operation instructions to the video presentation apparatus 100. The remote control 180 will be described in further detail with the following FIG. 6. The operational input unit 170 receives operation signals transmitted by the remote control 180, and outputs the content of the operation instructions to the computational processor 110.

FIG. 6 is a diagram illustrating details of buttons provided on the remote control 180. Besides a power button, channel buttons, and volume buttons, the remote control 180 includes a search mode button 181, an end search mode button 182, directional buttons 183, an OK button 184, and a back button 185.

The video presentation apparatus 100, following the operation instructions input by the user with the remote control 180, switches between a screen transition mode that changes the video content displayed by the screen display unit 150, and an on-screen selection mode that holds in place the video content being displayed on-screen and selects a particular instance of video content. The video presentation apparatus 100 also changes the video content displayed on-screen by the screen display unit 150. Hereinafter, examples of such operations and exemplary screen transitions will be described.

FIG. 7 is a diagram illustrating an exemplary initial screen in the screen transition mode. When the user presses the search button 181 of the remote control 180, the operational input unit 170 receives a corresponding operation signal, which is output to the computational processor 110. The computational processor 110 switches the operational mode of the video presentation apparatus 100 to the screen transition mode.

The computational processor 110 retrieves content data to be displayed on the initial screen of the screen transition mode from the content storage unit 120 according to a given rule (such as the newest content data, for example), decodes and otherwise processes the video information and audio information to generate video signals and audio signals, and causes these signals to be respectively output from the screen display unit 150 and the audio output unit 160. The processing related to virtual sound sources is similar to Embodiments 1 and 2, and thus further description thereof will be reduced or omitted. This applies similarly hereafter.

The layout of respective video content when the screen display unit 150 displays video content on-screen follows a predetermined rule. In the example illustrated herein, the time at which the video content was acquired (recorded, for example) is assigned to the horizontal axis direction of the screen while the broadcasting channel of the video content is assigned to the vertical axis direction of the screen, and respective instances of video content are displayed on a two-dimensional plane in correspondence with these properties.

FIG. 8 is a diagram illustrating exemplary screen transitions in the screen transition mode. Hereinafter, the screen transitions illustrated in FIG. 8 will be described.

FIG. 8(a) is a diagram illustrating an exemplary screen following FIG. 7 after the user presses the left directional button. The leftward direction in FIG. 8 is the direction leading to older recording times. Consequently, upon receiving a leftward operation signal from the remote control 180, the computational processor 110 retrieves content on the same channel with older recording times from the content storage unit 120, and causes the screen display unit 150 to display the retrieved content on-screen according to a procedure similar to FIG. 7. The number of new instances of content data to retrieve may be suitably fixed according to factors such as the size of the screen display unit 150, or the computational processor 110 may determine a suitable value each time.

FIG. 8(b) is a diagram illustrating an exemplary screen following FIG. 8(a) after the user presses the up directional button. The upward direction in FIG. 8 is the direction leading to higher channel numbers. Consequently, upon receiving an upward operation signal from the remote control 180, the computational processor 110 retrieves content in the same time slot on higher channels from the content storage unit 120, and causes the screen display unit 150 to display the retrieved content on-screen according to a procedure similar to FIG. 7.

FIG. 8(c) is a diagram illustrating an exemplary screen following FIG. 8(b) after the user presses the left directional button. The operational procedure is similar to that of FIG. 8(a).

FIG. 9 is a diagram illustrating exemplary screen transitions in an on-screen selection mode. When the user presses the OK button 184 of the remote control 180 while in the screen transition mode, the operational input unit 170 receives a corresponding operation signal, which is output to the computational processor 110. The computational processor 110 switches the operational mode of the video presentation apparatus 100 to the on-screen selection mode.

FIG. 9(a) is a diagram illustrating an exemplary initial screen in the on-screen selection mode. On the initial screen of the on-screen selection mode, the video signal playback unit 130 applies a video effect highlighting the content closest to the center of the screen, for example, from among the instances of video content that the screen display unit 150 was displaying on-screen in the immediately previous screen transition mode. Thus, the user is able to easily ascertain which video content is being selected on the current screen.

FIG. 9(b) is a diagram illustrating an exemplary screen following FIG. 9(a) after the user presses the down directional button. The computational processor 110 receives a downward operation instruction signal from the remote control 180 via the operational input unit 170. The computational processor 110 instructs the video signal playback unit 130 to highlight the instance of video content being displayed on-screen below the currently highlighted instance of video content. The video signal playback unit 130 highlights the relevant video content according to the instructions. In the case where multiple instances of video content exist below, instances of video content may be highlighted starting from the left side when viewing the screen, for example.

FIG. 9(c) is a diagram illustrating an exemplary screen following FIG. 9(b) after the user presses the down directional button. The operational procedure is similar to that of FIG. 9(b).

FIG. 10 is a diagram illustrating an exemplary screen transition when the user presses the OK button 184 on the remote control 180 while in the on-screen selection mode.

Upon receiving the operation signal for the OK button 184 of the remote control 180 while in the on-screen selection mode, the computational processor 110 instructs the video signal playback unit 130 to display the video content being highlighted at that moment in fullscreen. The video signal playback unit 130 causes the screen display unit 150 to display the relevant video content in fullscreen according to the instructions.

In addition, along with switching the video content to a fullscreen mode, the computational processor 110 also sets the position of the virtual sound source for the relevant video content to the center of the screen display unit 150. Since the screen size of the relevant video content increases due to being displayed in fullscreen, the depth of the virtual sound source may also be adjusted correspondingly.

FIG. 11 is an operational flowchart for a video presentation apparatus 100 according to Embodiment 3. Hereinafter, the steps in FIG. 11 will be described.

(FIG. 11: step S1100)

When the video presentation apparatus 100 is powered on, the computational processor 110 starts the present operational flow after executing initialization processes as appropriate by loading a control program from memory or the like.

(FIG. 11: step S1101)

The computational processor 110 causes the screen display unit 150 to display an initial screen. For example, when powering off, information such as content data names and windows positions of video content that the screen display unit 150 was displaying may be saved in memory, and the information from the time of the last power-off may be once again retrieved at the time of power-on. Thus, it is possible to reproduce the screen state from the time of the last power-off.

(FIG. 11: step S1102)

The computational processor 110 stands by for an operation signal from the remote control 180. The computational processor 110 proceeds to step S1103 upon receiving an operation signal from the operational input unit 170, and repeats this step of standing by for an operation signal until an operation signal is received.

(FIG. 11: step S1103)

The computational processor 110 determines whether or not the operation signal received from the remote control 180 is operation instructions causing the screen display unit 150 to display in fullscreen. Specifically, if the current screen mode is the on-screen selection mode illustrated in FIG. 9, and if the button that was pressed is the OK button 184, it is determined that the operation instructions are instructions for displaying the user-selected video content in fullscreen. The flow proceeds to step S1107 in the case of fullscreen instructions, and otherwise proceeds to step S1104.

(FIG. 11: step S1104)

The computational processor 110 determines which screen mode is indicated by the operation signal received from the remote control 180. The process proceeds to step S1105 in the case where the operation signal indicates the on-screen search mode, and proceeds to step S1106 in the case where the operation signal indicates the screen transition mode.

(FIG. 11: step S1104 (supplement))

The computational processor 110 determines that the instructions are for switching to the screen transition mode if the button that was pressed is the search mode button 181. Alternatively, the computational processor 110 determines that the instructions for switching to the screen transition mode in the case where the back button 185 is pressed when the current screen mode is the on-screen selection mode. The computational processor 110 determines that the instructions are for switching to the on-screen selection mode if the current screen mode is the screen transition mode and the button that was pressed is the OK button 184.

(FIG. 11: step S1105)

The computational processor 110 executes the on-screen search mode illustrated in FIG. 9.

(FIG. 11: step S1106)

The computational processor 110 executes the screen transition mode illustrated in FIG. 8.

(FIG. 11: step S1107)

The computational processor 110 executes the fullscreen display mode illustrated in FIG. 10.

(FIG. 11: step S1108)

The computational processor 110 ends the operational flow in the case of ending operation of the video presentation apparatus 100, or returns to step S1102 and repeats a similar process in the case of continuing operation.

The above thus describes operation of a video presentation apparatus 100 according to Embodiment 3. Note that although a remote control 180 is given as an example of an input device in Embodiment 3, other input devices may also be used. For example, operable buttons similar to those on the remote control 180 may also be provided on the main housing of the video presentation apparatus 100.

### Embodiment 3: Summary

As above, if a direction button 183 is pressed while executing a screen transition mode, a video presentation apparatus 100 according to Embodiment 3 instructs a video signal playback unit 130 to change the video content being displayed on-screen by the screen display unit 150. Thus, the user is able to visually search for desired video content while simultaneously displaying multiple instances of video content on-screen. In addition, because of the effects of virtual sound sources, the user is also able to aurally identify desired content while associating video and audio.

Furthermore, a video presentation apparatus 100 according to Embodiment 3, following directional operation instructions from a remote control 180, switches between a screen transition mode that changes the video content being displayed simultaneously, and an on-screen selection mode that holds in place the video content being displayed on-screen and selects a particular instance of video content. Thus, it is possible to use the screen transition mode to display multiple instances of video content on-screen and roughly search for desired video content, while using the on-screen selection mode to determine a particular instance of video content. In particular, since the screen transition mode enables the user to search for desired video content while associating video and audio, the configuration is also able to exhibit advantages as a video content searching apparatus.

### Embodiment 4

In Embodiment 4 of the present invention, exemplary implementations of the above Embodiments 1 to 3 will be described. The present invention may be with arbitrary apparatus insofar as the apparatus is related to video. Various examples of apparatus to which the present invention is applicable will be described with reference to FIGS. 12 to 18.

FIGS. 12 to 14 are diagrams illustrating respective examples of configuring the video presentation apparatus 100 in FIG. 1 as a television. FIGS. 15 and 16 are diagrams illustrating respective examples of configuring the video presentation apparatus 100 in FIG. 1 as a video projector system. FIG. 17 is a diagram illustrating an example of configuring the video presentation apparatus 100 in FIG. 1 as a system made up of a television cabinet and a television. Although FIGS. 12 to 17 all illustrate an example of arranging 10 speakers as the speaker array, it is sufficient for there to be multiple speakers.

In the case of implementing a video presentation apparatus 100 according to the present invention in a television, the placement of the audio output unit in the television may be freely determined. A speaker array in which the speakers of the audio output unit are arranged in a line may be provided below the television screen, as with the television illustrated in FIG. 12. A speaker array in which the speakers of the audio output unit are arranged in a line may be provided above the television screen, as with the television illustrated in FIG. 13. A speaker group in which transparent film speakers of the audio output unit are arranged in a line may be embedded into the television screen, as with the television illustrated in FIG. 14.

In addition, a video presentation apparatus 100 according to the present invention may be utilized in a video projector system. A speaker array may be embedded into the projector screen onto which a video projector projects video, as with the video projector system illustrated in FIG. 15. A speaker array may also be disposed behind a sound-transmitting screen onto which a video projector projects video, as with the video projector system illustrated in FIG. 16.

Besides the above, a video presentation apparatus 100 according to the present invention may also be implemented as a television and a television cabinet (television stand). A speaker array of arranged speakers may be embedded into a television cabinet onto which a television is mounted, as with the system (home theater system) illustrated in FIG. 17.

Also, when applying a video presentation apparatus according to the present invention to apparatus such as those described with reference to FIGS. 12 to 17, a switching unit enabling the user to switch between conducting and not conducting a wave field synthesis playback process (the process executed by the computational processor 110 and the audio signal playback unit 140 in FIG. 1) may also be provided. The switching unit may be switched by a user operation performed by operating a button provided on the main apparatus or by operating a remote control. For example, in the case of displaying only one video on-screen without conducting the wave field synthesis playback process, 2 ch audio data may be played back by a wave field synthesis playback method that disposes a virtual sound source as illustrated in FIG. 3.

FIG. 18 is a diagram illustrating an exemplary configuration of an audio output unit 160. As illustrated in FIG. 18, the audio output unit 160 may also play back audio by carrying out wave field synthesis using only the end speakers 1601L and 1601R at either end of the arrayed speakers 1601, as illustrated in FIG. 18. 5.1 ch audio data may be played back with similar wave field synthesis, or alternatively may be played back with only the front three channels using the center speaker 1601C and the two end speakers 1601L and 1601R.

### Embodiment 5

The processing by the respective functional units may also be realized by recording a program for realizing the functions of the computational processor 110, the video signal playback unit 130, and the audio signal playback unit 140 of a video presentation apparatus 100 described in the foregoing Embodiments 1 to 4 onto a computer-readable storage medium, and causing a computer system to read and execute the program recorded onto the storage medium. Note that the “computer system” referred to herein is assumed to include an operating system (OS) and hardware such as peripheral devices.

Moreover, the above program may be a program for realizing part of the functions discussed earlier, but may also be able to realize the functions discussed earlier in combination with programs already recorded onto the computer system.

In addition, the “storage medium” storing the above program refers to a computer-readable portable medium such as a flexible disk, a magneto-optical disc, read-only memory (ROM), or a CD-ROM, or a storage device such as a hard disk built into the computer system. Furthermore, the storage medium also encompasses media that briefly or dynamically retain the program, such as a communication line in the case of transmitting the program via a network such as the Internet or a communication channel such as a telephone line, as well as media that retain the program for a given period of time, such as volatile memory inside the computer system acting as the server or client in the above case.

### REFERENCE SIGNS LIST

100 video presentation apparatus
110 computational processor
120 content storage unit
130 video signal playback unit
140 audio signal playback unit
150 screen display unit
151 to 153 video content
160 audio output unit
1601 arrayed speakers
1601L, 1601R end speaker
1601C center speaker
161 to 163 virtual sound source
170 operational input unit
180 remote control
181 search mode button
182 end search mode button
183 directional buttons
184 OK button
185 back button
200 user

1. A video presentation apparatus that presents video, characterized by comprising:
a video playback unit that plays back video information and outputs a video signal;
an audio playback unit that plays back audio information and outputs an audio signal;
a screen display unit that uses the video signal output by the video playback unit to display video on-screen;
an audio output unit that uses the audio signal output by the audio playback unit to output audio; and
a computational unit that controls the behavior of the video playback unit and the audio playback unit;
wherein the computational unit
sets the position of a virtual sound source for the video at the position where the screen display unit is displaying the video on-screen, on or near a straight vertical line from that position, or on or near a straight horizontal line from that position, and
causes the audio playback unit to output the audio signal so as to aurally or audiovisually reproduce the state of the audio being produced from the virtual sound source.

2. The video presentation apparatus according to claim 1, characterized in that the audio playback unit converts the audio information into a monaural signal.

3. The video presentation apparatus according to claim 1, characterized in that the computational unit sets the position of the virtual sound source in the depth direction according to the size of the video being displayed on-screen by the screen display unit.

4. The video presentation apparatus according to claim 1, characterized by comprising:
an operational input unit that accepts operational input and outputs the operational input to the computational unit;
wherein the screen display unit simultaneously displays a plurality of the videos on-screen, and
the computational unit
upon receiving operational input from the operational input unit issuing instructions to change the videos being displayed on-screen simultaneously by the screen display unit,
causes the video playback unit to play back video information corresponding to the videos after the change, and
causes the screen display unit to display the videos on-screen using the video signals corresponding to the videos after the change.

5. The video presentation apparatus according to claim 3, wherein
the operational input unit receives screen mode switching operational input that switches between
a screen transition mode that changes the videos being displayed on-screen simultaneously by the screen display unit, and
an on-screen selection mode that holds in place the videos being displayed on-screen by the screen display unit, and selects a video from among the plurality of the videos being displayed on that screen, and
the computational unit
upon receiving the screen mode switching operational input from the operational input unit, the computational unit switches the screen display unit to the mode specified by the screen mode switching operational input,
when executing the screen transition mode, upon receiving operational input from the operational input unit issuing instructions to change the videos being displayed on-screen simultaneously by the screen display unit, the computational unit causes the video playback unit to play back video information corresponding to the videos after the change, while also causing the screen display unit to display the videos using the video signals corresponding to the videos after the change, and
when executing the on-screen selection mode, upon receiving operational input from the operational input unit that selects one of the plurality of the videos being displayed on-screen by the screen display unit, the computational unit displays that video in fullscreen, while also setting the position of the virtual sound source to the center of the screen display unit.

6. A video presentation method that presents video using a video presentation apparatus provided with
a video playback unit that plays back video information and outputs a video signal,
an audio playback unit that plays back audio information and outputs an audio signal,
a screen display unit that uses the video signal output by the video playback unit to display video on-screen, and
an audio output unit that uses the audio signal output by the audio playback unit to output audio,
the video presentation method being characterized by including:
a step of setting a virtual sound source for the video at the position on the screen display unit where the screen display unit is displaying the video on-screen; and
a step of causing the audio playback unit to output the audio signal such that the audio output unit forms a sound field that imitates the state of the audio being produced from the virtual sound source.

7. A video presentation program, characterized by causing a computer to execute the video presentation method according to claim 6.

8. A computer-readable storage medium, characterized by storing the video presentation program according to claim 7.
